(19) United States
(12) Patent Application Publication
(10) Pub. No.: US 2020/0257232 A1
(43) Pub. Date: Aug. 13, 2020

(54) IMAGE FORMING APPARATUS AND GLOSS ADJUSTMENT METHOD

(71) Applicant: KONICA MINOLTA, INC., Tokyo (JP)

(72) Inventors: Shigeo UETAKE, Tokyo (JP); Toru HAYASE, Toyokawa-shi (JP); Taira KITAGAWA, Osaka (JP)

(73) Assignee: KONICA MINOLTA, INC., Tokyo (JP)

(21) Appl. No.: 16/778,461

(22) Filed: Jan. 31, 2020

(30) Foreign Application Priority Data
Feb. 8, 2019 (JP) 2019-021768

(51) Int. Cl. G03G 15/00

(52) U.S. Cl. CPC G03G 15/6585

(57) ABSTRACT

Provided is an image forming apparatus including: a fixer that fixes a color material on a medium to the medium; a heater that heats a zone set in the color material fixed to the medium by the fixer; and a hardware processor that controls operations of the fixer and the heater, wherein the hardware processor performs adjustment of glossiness in an image fixed by the fixer and performs adjustment of glossiness in the zone heated by the heater, respectively, based on gloss information indicating glossiness in each part of a target image recorded on the medium.

### CROSS-REFERENCE TO RELATED APPLICATIONS

The entire disclosure of Japanese Patent Application No. 2019-021768 filed on Feb. 8, 2019 is incorporated herein by reference in its entirety.

### BACKGROUND

### Technological Field

The present invention relates to an image forming apparatus and a gloss adjustment method.

### Description of the Related Art

There is an image forming apparatus that forms images by applying and fixing toner on a recording medium. The toner on the recording medium is fixed by being heated and pressed. The characteristic of the surface of the toner changes depending on the condition at the time of fixation, and gloss of the image is adjusted.

Among formed images, there may be an image in which a gloss characteristic only in a part thereof is changed. JP 2008-129061A and JP 2002-278359A disclose a technique that applies heat to a necessary zone again on a recording medium on which an image is already being fixed to reduce gloss of the corresponding part or to adjust glossiness thereof according to the quantity of heat.

### SUMMARY

However, the part to be worked on again may become wide depending on the area to change the gloss, which deteriorates the efficiency.

The object of the present invention is to provide an image forming apparatus and a gloss adjustment method capable of adjusting the gloss part of a formed image more efficiently.

To achieve at least one of the abovementioned objects, according to an aspect of the present invention, an image forming apparatus reflecting one aspect of the present invention comprises: a fixer that fixes a color material on a medium to the medium; a heater that heats a zone set in the color material fixed to the medium by the fixer; and a hardware processor that controls operations of the fixer and the heater, wherein the hardware processor performs adjustment of glossiness in an image fixed by the fixer and adjustment of glossiness in the zone heated by the heater based on gloss information indicating glossiness in each part of a target image recorded on the medium.

To achieve at least one of the abovementioned objects, according to another aspect of the present invention, a gloss adjustment method reflecting one aspect of the present invention is a gloss adjustment method of the image forming apparatus comprising a fixer that fixes a color material on a medium to the medium, and a heater that heats a zone set in the color material fixed to the medium by the fixer, and the gloss adjustment method comprises: performing first adjustment of glossiness in an image fixed by the fixer based on gloss information indicating glossiness in each part of a target image recorded on the medium; and performing second adjustment of glossiness in the zone heated by the heater based on the gloss information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram showing a schematic configuration of an image forming apparatus according to a first embodiment;

FIG. 2 is a block diagram showing a functional configuration of the image forming apparatus;

FIG. 3A is a graph for describing temperature drop and glossiness at the time of fixing toner;

FIG. 3B is a graph for describing temperatures of the surface of the toner and glossiness at the time of adjusting glossiness;

FIG. 4A is a chart showing an example of an image in which setting of gloss is partially different;

FIG. 4B is a chart showing an example of an image in which setting of gloss is partially different;

FIG. 5A is a flowchart showing a control procedure of gloss adjustment control processing;

FIG. 5B is a flowchart showing a control procedure of gloss adjustment control processing;

FIG. 6 is a diagram showing a schematic configuration of an image forming apparatus according to a second embodiment;

FIG. 7A is a diagram showing a schematic configuration of an image forming apparatus according to a third embodiment;

FIG. 7B is a diagram showing a schematic configuration of the image forming apparatus according to the third embodiment; and

FIG. 8 is a table showing an example of results acquired by performing gloss adjustment.

### DETAILED DESCRIPTION OF THE EMBODIMENTS

Hereinafter, embodiments of the present invention will be described by referring to the accompanying drawings. However, the scope of the invention is not limited to the disclosed embodiments.

### First Embodiment

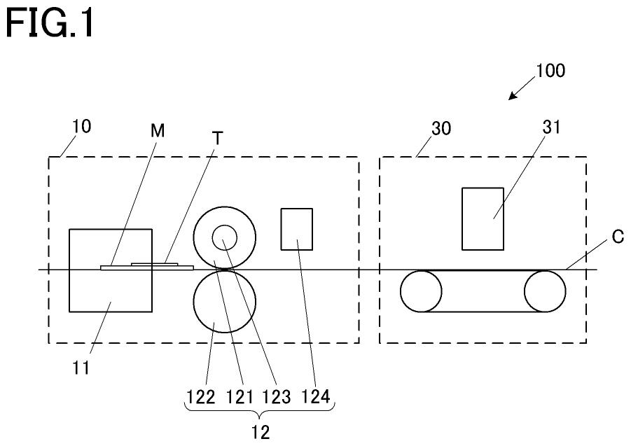

FIG. 1 is a diagram showing a schematic configuration of an image forming apparatus 100 according to the first embodiment.

The image forming apparatus 100 according to the embodiment includes a main body 10 and a gloss adjustor 30 (heater).

The main body 10 includes an image forming operator 11 and a fixer 12. The image forming operator 11 applies toner T on a recording medium M (medium) conveyed along a conveyance path C, and the fixer 12 fixes the toner T (color material). While the recording medium M herein is various kinds of sheet, the recording medium M is not limited thereto but may be a film material made of resin or the like, for example.

The image forming operator 11 fixes the toner on the recording medium M according to forming target image data. The image forming operator 11 may be any type that applies the toner T on the recording medium M by a conventionally known electrophotographic configuration.

The fixer 12 presses the toner T on the recording medium M while applying heat. The fixer 12 includes a fixing roller 121, a pressure roller 122, a heater 123, a cooler 124, and the like. The fixing roller 121 pinches the recording medium M with the pressure roller 122, and pressurizes the toner T while applying heat by the surface of the fixing roller 121 that is heated by the heater 123. The fixing roller 121 may be rotated by a motor or the like at a conveying speed of the recording medium. The fixing roller 121 and the pressure roller 122 configure a pressurizer according to the embodiment.

The heater 123 is extended into a rotation shaft part of the fixing roller 121, and heats a roller member of the fixing roller 121 to an appropriate temperature. The heater 123 is a halogen lamp heater, for example.

The pressure roller 122 forms a fixing nip between with the fixing roller 121 and fixes the toner T on the recording medium M. The pressure roller 122 may be a driven roller that is rotated according to conveyance of the recording medium M.

The cooler 124 cools down the recording medium M and the toner T after a heating and pressuring operation, and adjusts the temperature drop rate of the toner T. The cooler 124 herein is a fan, and generates air to be blown to the surface (toner T) of the recording medium M to increase the temperature drop rate.

The gloss adjustor 30 partially adjusts the gloss state of the toner T on the recording medium M. The gloss adjustor 30 includes a light irradiator 31. The light irradiator 31 may be of a type in which a great number of laser beam oscillators or LED (Light Emitting Diode) elements are disposed in the direction vertical to the conveying direction of the recording medium M, and radiate a prescribed elements at a prescribed timing while conveying the recording medium M so as to locally irradiate light and heat a zone (set zone) to adjust glossiness within the toner T on the recording medium M. The wavelength of the light may be defined according to the toner and/or types of the recording medium (basis weight, thickness, and the like). In the gloss adjustor 30, the light irradiation intensity of each of the elements may be separately adjustable. The gloss adjustor 30 exists separately from the main body 10, and is attached on the downstream side of the main body 10 as a post-processing apparatus.

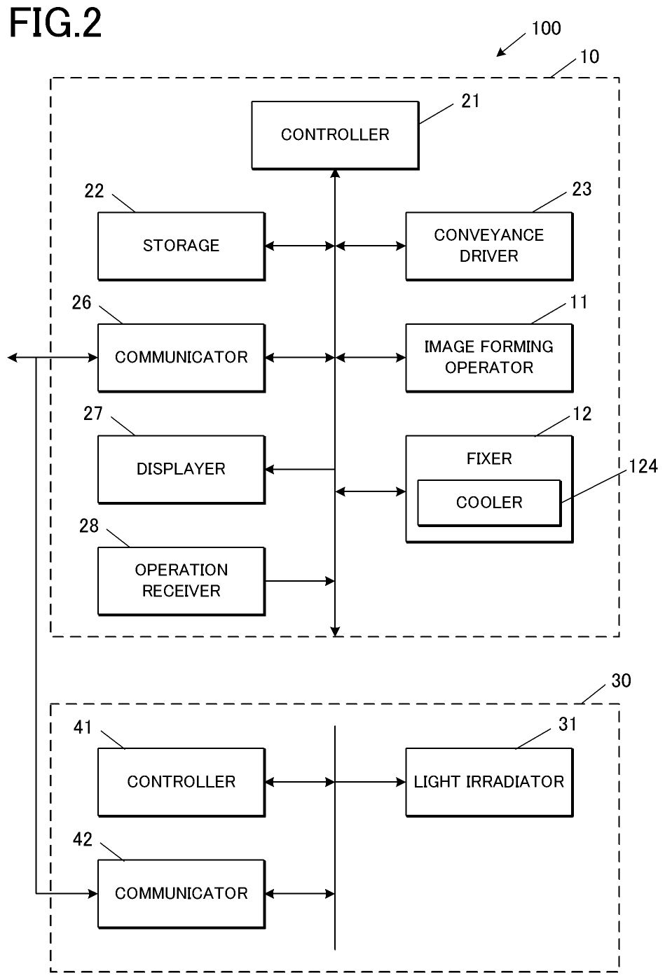

FIG. 2 is a block diagram showing a functional configuration of the image forming apparatus 100. The main body 10 includes a controller (hardware processor) 21, a storage 22, a conveyance driver 23, a communicator 26, a displayer 27, an operation receiver 28, and the like in addition to the image forming operator 11 and the fixer 12. The gloss adjustor 30 includes a controller 41 and a communicator 42 in addition to the light irradiator 31.

The controller 21 controls operations of the main body 10. The controller 21 includes a CPU (Central Processing Unit), a RAM (Random Access Memory), and the like, and performs processing for controlling operations of each component related to image forming operations according to a control program and the like. The controller 21 may perform part of processing by a dedicated hardware logic circuit or the like.

The storage 22 stores image forming job data including recording target image data, the control program, and various kinds of setting data. In the recording target image data, as will be described later, gloss information indicating glossiness of each part may be included. The storage 22 includes an auxiliary storage device such as an HDD (Hard Disk Drive) and may also include a DRAM (Dynamic Random Access Memory) and/or a flash memory, for example.

The conveyance driver 23 shifts the recording medium M at a set speed based on control of the controller 21. Furthermore, the conveyance driver 23 performs switching operations according to the moving path of the recording medium M, such as acquiring the recording medium from a tray according to a supply source of the recording medium M, outputting thereof to a tray according to an output destination tray, inverting back and front of the recording medium M. The conveyance driver 23 includes a motor or the like for rotating the roller. The number and the like of the motor may be defined as appropriate according to the conveyance path and the like.

The communicator 26 controls communication with external electronic devices and the like. The communicator 26 transmits and receives data according to appropriate standards such as TCP/IP via a LAN (Local Area Network), for example. Furthermore, the communicator 26 may be able to transmit and receive data on one-on-one basis according to the standard such as USB (Universal Serial Bus). The communicator 26 herein is connected to the communicator 42 of the gloss adjustor 30.

The controller 41 of the gloss adjustor 30 controls the gross adjustment processing on the recorded image in association with the processing of the main body 10 (with delay of the conveying speed of the recording medium M). The controller 41 includes a CPU and a RAM. Information such as the adjustment direction of the gloss (whether to partially increase the gloss or to partially decrease the gloss) and the like may be acquired from the controller 41 and executed.

The communicator 42 controls communication with the external electronic devices. The communicator 42 may be the same one with the communicator 26. The communicator 42 herein is capable of transmitting and receiving data to/from the communicator 26.

Next, the gloss adjustment will be described.

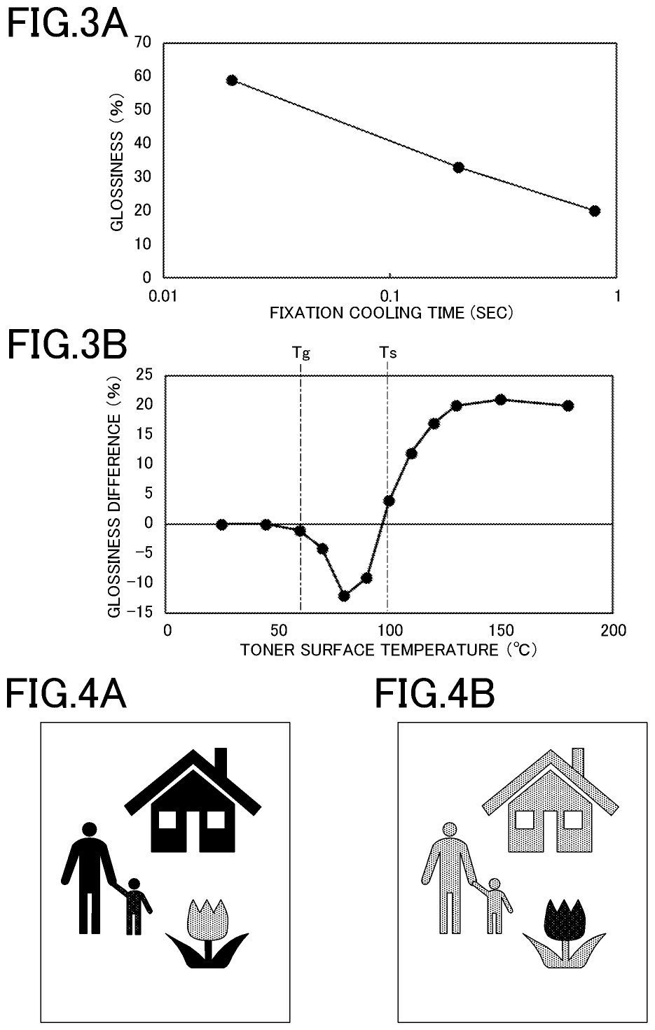

FIG. 3A is a graph for describing temperature drop and glossiness at the time of fixing toner. FIG. 3B is a graph for describing temperatures of the surface of the toner and glossiness at the time of adjusting glossiness.

Glossiness of the toner T becomes higher as the surface becomes a more uniformly flat state and becomes lower as the surface comes to have minute unevenness and the like. The particulate toner is melted and deformed into a film by being heated at the time of fixation. The film toner T exhibits rubber-like viscoelasticity at glass transition temperature Tg (first reference temperature) or higher. Thereby, as shown in FIG. 3A, when it takes long time to sufficiently lower the temperature after the pressure by the fixer 12 is released, compression of the surface at the time of fixation is gradually restored by the elasticity and the gloss is decreased. When the temperature quickly drops, the surface is solidified while being compressed so that gloss remains in a high state. That is, glossiness at the time of fixation is defined according to the pressurization state and tendency of temperature changes after heating is stated until the toner T is lowered again to the glass transition temperature Tg or less. The time required for lowering the temperature herein is adjusted by the operation of the cooler 124 (first adjustment step).

When reheating the toner solidified by the fixing operation, as shown in FIG. 3B, the viscoelasticity described above is restored and the gloss is changed to a decreasing direction in a zone between the glass transition temperature Tg and the softening point temperature Ts. When the temperature of the toner is increased to the softening point temperature Ts or higher, the toner is liquidized and plastically deformed so that the gloss is changed to an improving direction.

For partially adjusting the gloss state afterwards, a whole image in an appropriate gloss state may be formed according to cooling time, and the part in a gloss state that is different from the gloss state of the formed image may be adjusted thereafter. At the time of fixation, the cooler 124 is operated to increase the cooling rate of the toner T to form the whole image with high gloss. In order to adjust the cooling time, the cooler 124 may provide a nozzle at the tip of the fan, for example, and each of the flow amount and temperature of the air as well as the shape of the nozzle may be adjusted. In the meantime, a whole image with low gloss is formed by cooling the toner T more slowly than the case of operating the cooler 124 by not operating the cooler 124. In order to generate a low-gloss part with the adjustment of the gloss performed afterwards, the temperature of the toner T solidified without being elastically restored may be increased again to a temperature between the glass transition temperature Tg and the softening point temperature Ts without applying pressure so as to restore the compressed part. Furthermore, for generating a high-gloss part, the temperature of the toner T may be increased to the softening point temperature Ts or higher to be plastically deformed (second adjustment step). While it is described herein to have only two kinds of glossiness that are the high-gloss part and the low-gloss part, there may be three or more gloss levels.

At this time, it takes time and effort to perform adjustment to change the middle gloss state to both the high-gloss state part and the low-gloss state part, while the gloss difference becomes small when adjustment to only one of those state parts is performed. Thus, the image forming apparatus 100 selects whether to perform the first processing (first gloss adjustment operation) with which a whole image with high gloss (prescribed gloss image) is formed and fixed once and the gloss of a low-gloss part is partially decreased or to perform the second processing (second gloss adjustment operation) with which a whole image with low gloss is formed and fixed once and the gloss of a high-gloss part is partially increased. By defining glossiness as high as possible for the high-gloss image at the time of fixation and defining glossiness as low as possible for the low-gloss image, the gloss difference between the high-gloss part and the low-gloss part can be made significant.

Both the first processing and the second processing perform processing for canceling the gloss state defined in advance, so that wider the zone to be cancelled, the wider the zone to be worked on again. Accordingly, the power consumption is increased. Thus, the image forming apparatus 100 acquires in advance the area ratio between the high-gloss part and the low-gloss part in the recording target image data, and selects the more efficient one. That is, in the image forming apparatus 100, the adjustment of glossiness at the time of fixation by the fixer 12 and the adjustment of glossiness performed in a part (set zone) by the gloss adjustor 30 are defined according to the gloss information of the target image.

FIG. 4A and FIG. 4B are charts showing examples of an image in which setting of the gloss is partially different.

In the forming target image data, the setting of gloss is stored by being associated with each of positions, zones, or elements. The setting of gloss may be included in the forming target image data or may be held in a separate file. For example, in FIG. 4A, the area of the low-gloss part in gray is sufficiently smaller compared to the area of the high-gloss part in black. In such case, low-gloss processing for forming the low-gloss part performed after forming a whole image with high gloss. Furthermore, in FIG. 4B, the area of the high-gloss part is sufficiently smaller than the area of the low-gloss part. In such case, high-gloss processing for forming the high-gloss part is performed after forming a whole image with low gloss. This makes it possible to narrow the zone of the processing performed to cancel the gloss state defined once.

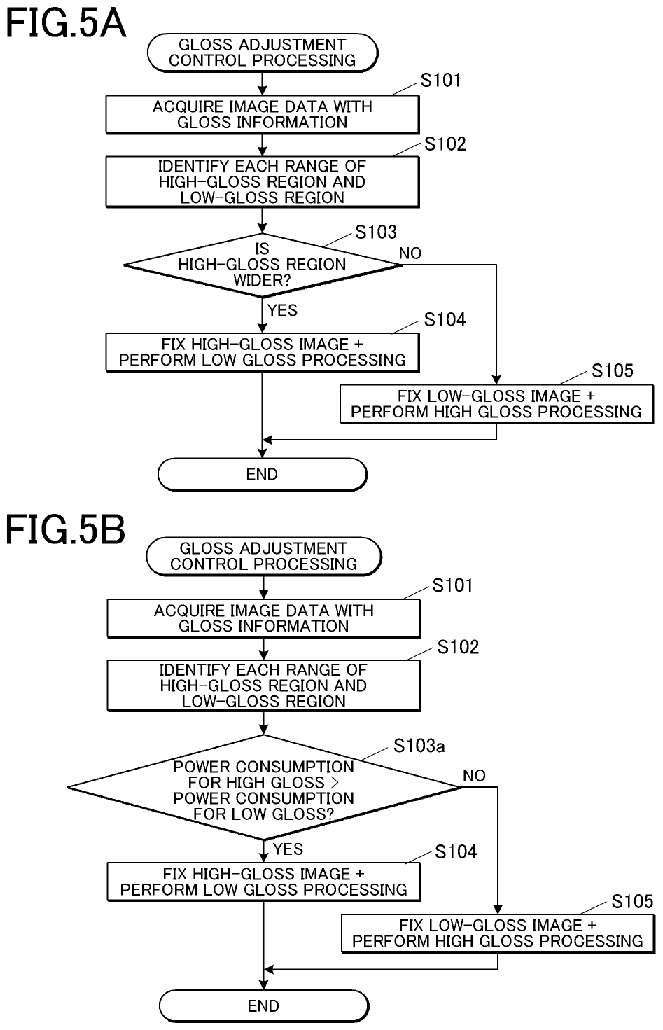

FIG. 5A and FIG. 5B are flowcharts showing the control procedures of the controller 21 regarding the gloss adjustment control processing (the gloss adjustment method of the embodiment) executed by the image forming apparatus 100. This processing is started upon acquiring an image forming instruction.

As shown in FIG. 5A, the controller 21 (CPU) acquires the recording target image data together with the gloss information (step S101). The controller 21 identifies each zone of the high-gloss region and the low-gloss region in the recording target image (step S102).

The controller 21 determines whether or not the high-gloss region is wider than the low-gloss region (area ratio) (step S103). If determined that the high-gloss region is wider (the area is wider) (“YES” in step S103), the controller 21 causes the main body 10 to form and fix a whole image with high gloss and causes the gloss adjustor 30 to perform setting related to the first processing for executing the low-gloss processing (step S104). Then, the controller 21 ends the gloss adjustment control processing. If determined that the high-gloss region is not wider than the low-gloss region (the area is the same or narrower) (“NO” in step S103), the controller 21 causes the main body 10 to form and fix a whole image with low gloss and causes the gloss adjustor 30 to perform the second processing for executing the high-gloss processing. Then, the controller 21 ends the gloss adjustment control processing.

Alternatively, the gloss adjustment control processing of Modification Example shown in FIG. 5B may be executed. In the execution content of the gloss adjustment control processing of Modification Example shown in FIG. 5B, the processing of step 5103 is replaced with the processing of step S103a.

Herein, the controller 21 does not simply compare the area of the high-gloss region with the area of the low-gloss region but determines whether or not the power consumed by the gloss adjustor 30 for making it high gloss is larger than the power consumed for making it low gloss (step S103a). If the power consumed for making it high gloss is larger than the power consumed for making it low gloss (“YES” in step S103a), the controller 21 sets the first processing for performing the low-gloss processing after forming and fixing the image with high gloss (step S104). If the power consumed for making it high gloss is not larger than (smaller than or equal to) the power consumed for making it low gloss (“NO” in step S103a), the controller 21 sets the second processing for performing the high-gloss processing after forming and fixing the image with low gloss (step S105).

As described above, the gloss adjustor 30 of the image forming apparatus 100 according to the embodiment increases the temperature to a higher temperature in the case of partially making it high gloss than the case of making it partially low gloss so that the power consumption thereof becomes larger (here, the power consumed for the operation of the cooler 124 at the time of making the whole image high gloss is sufficiently smaller than the power consumed in the light irradiator 31, so that it is not taken into consideration). Therefore, in the light adjustment control processing of this Modification Example, whether to select the first processing or the second processing may be determined not only according to the extent of the area but also according to the product of the consumption of power (power per unit area) and the area by taking the power consumption into consideration. For example, in a case where the high-gloss processing is 2.5 J/cm² and the low-gloss processing is 1.0 J/cm², the second processing is performed when the proportion of the low-gloss region is larger than 5:2 which is the proportion between the low-gloss region and the high-gloss region and the first processing is performed when the proportion of the low-gloss region is smaller than that.

### Second Embodiment

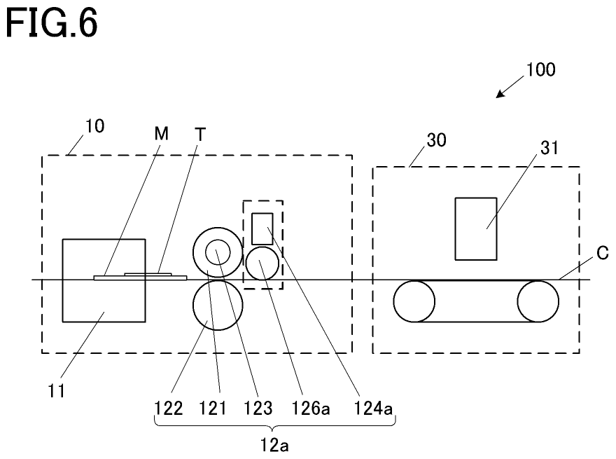

FIG. 6 is a diagram showing a schematic configuration of the image forming apparatus 100 according to the second embodiment. In the image forming apparatus 100 according to the second embodiment, the fixer 12 of the image forming apparatus 100 according to the first embodiment is replaced with a fixer 12a . Other components are the same as those of the first embodiment, so that same reference signs are used and explanations thereof are not repeated.

In the image forming apparatus of the second embodiment, the fixer 12a includes a cooler 124a instead of the cooler 124, a pressure roller 126a, and the like. The cooler 124a cools the pressure roller 126a. The pressure roller 126a is located on the downstream side of the fixing roller 121 along a conveyance path C and cools the toner T on the recording medium M while applying pressure. As the pressure roller 126a, a metallic roller is used, for example. For acquiring a high-gloss image, the toner T may be cooled while being pressured by the pressure roller 126a. Thereby, the toner T is solidified without restoration of the elastic deformation.

The pressure roller 126a is movable in a direction leaving away from the conveyance path C. The cooler 124a may also be movable together with the pressure roller 126a. For fixing a low-gloss image, the pressure roller 126a is not brought to be in contact to apply pressure to the recording medium M and the toner T so that the temperature naturally drops and the toner T is solidified without applying pressure. In this case, the elastic deformation of the toner T is restored and glossiness of the fixed image is decreased. That is, the controller 21 increases and decreases the pressurizing time of the toner T by moving the pressure roller 126a up and down so as to adjust (increase and decrease) glossiness of the whole image to be fixed.

### Third Embodiment

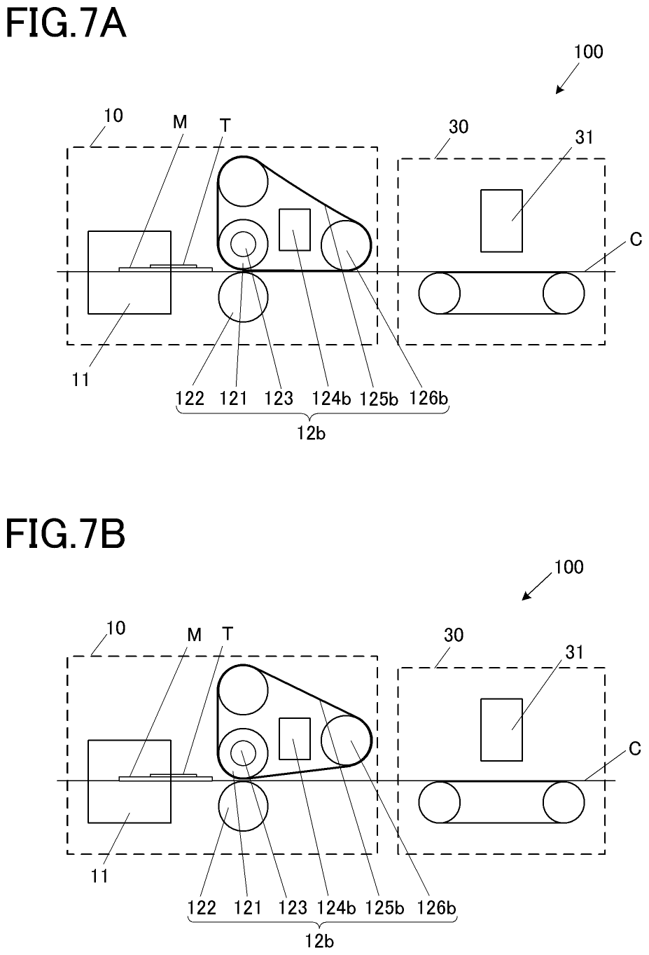

FIG. 7A and FIG. 7B are diagrams showing schematic configurations of the image forming apparatus 100 according to the third embodiment. In the image forming apparatus 100 according to the third embodiment, the fixer 12 of the image forming apparatus 100 according to the first embodiment is replaced with a fixer 12b. Other components are the same as those of the first embodiment, so that same reference signs are used and explanations thereof are not repeated.

In the image forming apparatus 100 of the third embodiment, the fixer 12b includes a cooler 124b for cooling a belt 125b instead of the cooler 124 that cools the recording medium M. The fixer 12b further includes the belt 125b and a rotation support 126b.

The cooler 124b may also be a blower fan like the case of the cooler 124, for example, as long as it is capable of cooling the belt 125b.

The belt 125b is placed across the fixing roller 121 and the rotation support 126b. Here, the belt 125b is heated by making contact with the fixing roller 121 to be in an appropriate temperature that is at the glass transition temperature Tg or higher to heat the recording medium M and the toner T. The belt 125, after being away from the fixing roller 121, may be cooled by the cooling operation of the cooler 124b.

The rotation support 126b is movable between a position along the conveyance path C and an isolated position. In a case where the rotation support 126b is located along the conveyance path C as shown in FIG. 7A, the belt 125b lowers the temperature of the toner T on the recording medium M to be less than the glass transition temperature Tg while continuously contact-pressuring (while applying pressure on) the recording medium M between the fixing roller 121 and the rotation support 126b. That is, in such case, a high-gloss image is fixed. In a case where the rotation support 126b is located at a position isolated from the conveyance path C as shown in FIG. 7B, the belt 125b contacts with the recording medium M only in the vicinity of a nipped part between the fixing roller 121 and the pressure roller 122 and leaves from the recording medium M thereafter. Therefore, the toner T is lowered in temperature without being pressurized. In this case, even if the cooler 124b continues the cooling operation, the recording medium M is not directly cooled because of the belt 125b being an obstacle. That is, the cooler 124b at this time operates as a heat retainer that suppresses the temperature drop. Alternatively, the operation of the cooler 124b may be stopped as well. In those cases, the temperature of the toner T gradually drops without being pressurized, so that a low-gloss image is fixed.

That is, the fixer 12b is capable of switching the temperature drop rate of the toner T according to the position of the rotation support 126b. With such configuration, the first processing or the second processing set in the gloss adjustment control processing is appropriately executed so as to efficiently form an image in which the high-gloss part and the low-gloss part are mixed.

While the case of the cooler 124b has been described herein as an example, it is also possible to employ a configuration (heat retainer) for rather increasing or keeping the temperature when the temperature of the toner T naturally and rapidly drops. In such case, the belt 125b does not contact with the recording medium M but is capable of decreasing the gloss by heating the recording medium M and the toner T without applying pressure at a close distance, for example.

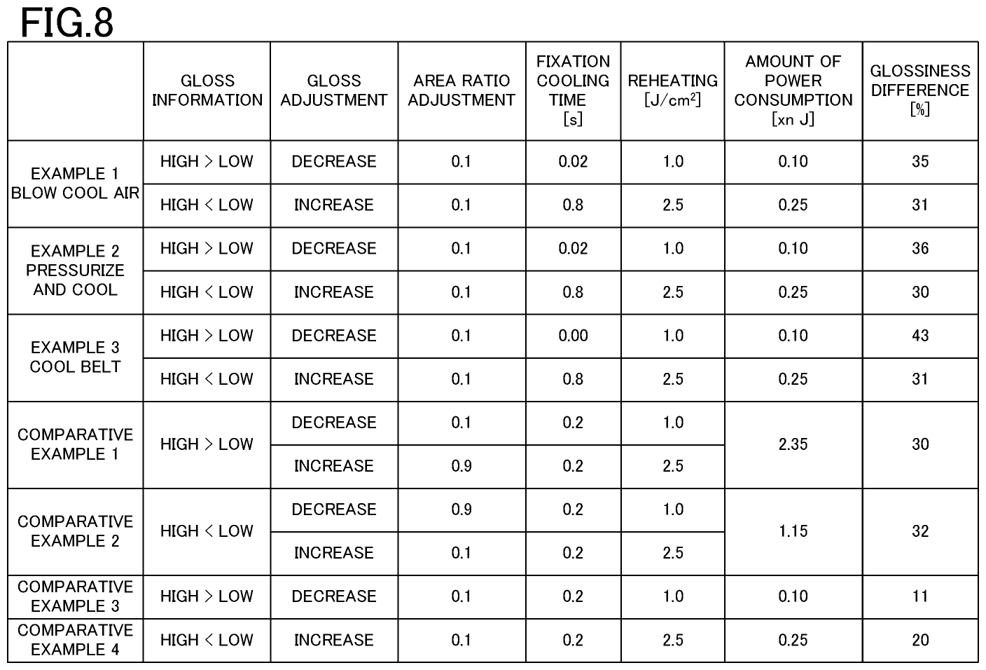

FIG. 8 is a table showing an example of results acquired by performing gloss adjustment in each of the embodiments and Comparative Examples.

In Examples 1 to 3, fixation and gloss adjustment of the same configuration as those of each of the image forming apparatuses 100 according to the first to third embodiments were performed. Herein, an image shown in FIG. 4A or FIG. 4B was formed on a POD gloss coat sheet (product of Oji Paper Co., Ltd.) with a basis weight of 128 gsm, and the gloss adjustor 30 irradiated light by an LED light source with the center wavelength of 385 nm. In Example 1, the fixer 12 sprayed the air to make the time for lowering the temperature to the glass transition temperature Tg as 0.02 sec in a case of high gloss, while the time for decreasing the temperature was 0.8 sec in a case of low gloss without spraying the air.

Gloss information indicates whether there is more high-gloss part or more low-gloss part, and the adjustment area ratio indicates the proportion of the area to be adjusted by the gloss adjustor 30 with respect to the whole area. With the gloss adjustment performed by the gloss adjustor 30, power of 1.0 J/cm² (energy per unit area) is required for reheating performed for generating the low-gloss part while power of 2.5 J/cm² (energy per unit area) is required for reheating performed for forming the high-gloss part. The amount of power consumption is a value acquired by multiplying the adjustment area ratio to the power, which is 1/n times the coefficient of actual energy consumption.

In Example 2, the metallic pressure roller 126a was provided on the downstream side of the fixing roller 121, and pressure was applied by the pressure roller 126a in a case of high gloss.

In Example 3, the cooler 124b is the same as the cooler 124. The toner T was cooled while being pressurized (herein, the fixation cooling time was “0.0”) in a case of high gloss, while the belt 125 was isolated from the recording medium M and the toner T to keep the temperature by suppressing the influence of the cooler 124 in a case of low gloss.

In Comparative Examples 1 and 2, the fixation cooling time was set to an intermediate level (0.2 sec), and each of the high-gloss part and the low-gloss part was heated and adjusted by the gloss adjustor 30. Comparative Example 1 is a case where there is more high-gloss part, while Comparative Example 2 is a case where there is more low-gloss part.

In Comparative Example 3, after the intermediate level of fixation cooling time same as that of Comparative Examples 1 and 2, only the processing for adjusting the gloss of the low-gloss part was performed by the gloss adjustor 30.

In Comparative Example 4, after the intermediate level of fixation cooling time same as that of Comparative Examples 1 and 2, only the processing for adjusting the gloss of the high-gloss part was performed by the gloss adjustor 30.

In all of Examples 1 to 3, the gloss difference of 30% or more can be acquired while suppressing the energy consumption. This is sufficiently larger than that of Comparative Examples 3 and 4. While the gloss difference about the same as that of the Examples 1 to 3 can be acquired in Comparative Examples 1 and 2, the amount of the power consumption becomes larger by about one digit.

As described, the image forming apparatus 100 of the embodiments includes: the fixer 12 that fixes the toner T on the recording medium M to the recording medium M; the gloss adjustor 30 that heats the set zone of the toner T fixed on the recording medium M by the fixer 12; and the controller 21 that controls operations of the fixer 12 and the gloss adjustor 30. The controller 21 performs adjustment of glossiness in an image fixed by the fixer 12 and adjustment of glossiness of the heating zone by the gloss adjustor 30 based on the gloss information that indicates glossiness in each part of the target image recorded on the recording medium M.

As described, by appropriately combining glossiness of the image fixed by the fixer 12 with the zone and glossiness to be adjusted by the gloss adjustor 30, it is possible to suppress unnecessary time and effort and to efficiently form an image with a significant gloss difference.

Furthermore, the controller 21 selects either the first processing with which a prescribed high-gloss image is fixed by the fixer 12 and then the gloss of the high-gloss image is partially decreased by the gloss adjustor 30 or the second processing with which a low-gloss image with less gloss than the high-gloss image is fixed by the fixer 12 and then the gloss of the low-gloss image is partially increased by the gloss adjustor 30 according to the gloss information. This makes it unnecessary to perform the processing for increasing the gloss and the processing for decreasing the gloss together by the gloss adjustor 30, so that the processing becomes easier. Furthermore, it is simply required to partially readjust only the part where glossiness is different from the gloss of the whole image, so that the adjustment amount can be reduced.

Furthermore, the fixer 12 includes the fixing roller 121, the pressure roller 122, and the heater 123 as the pressurizer to apply heat to the toner T and apply pressure to the recording medium M. The controller 21 defines the pressurization by the pressurizer and the tendency of the temperature change after starting heating until the temperature of the toner T drops to the first reference temperature (glass transition temperature Tg) according to glossiness in the image fixed by the fixer 12.

This makes it possible to easily form an image with appropriate glossiness at the time of fixation. Therefore, the processing becomes easier than defining various kinds of gloss only by the operations of the gloss adjustor 30.

Furthermore, the fixer 12 extends the time required for lowering the temperature of the toner T to be longer for the case of fixing the low-gloss image than the case of fixing the high-gloss image. By keeping long the temperature to the glass transition temperature Tg or higher according to the viscoelasticity of the toner T, the low-gloss image can be easily acquired.

Furthermore, the fixer 12 includes the cooler 124 for cooling the toner T, and the controller 21 switches the operations of the cooler 124 according to glossiness of the whole image to be fixed.

That is, by adjusting the continuing time of the glass transition temperature Tg or higher according to the operations of the cooler 124, the whole glossiness can be easily adjusted.

Furthermore, the fixer 12 lowers the temperature of the toner T while applying pressure to the toner T when fixing the high-gloss image. As described, it is possible to acquire the high-gloss image by simply adjusting the pressurization state instead of adjusting the time until the temperature drops to the gloss transition temperature Tg or lower, so that the control operations can be done more easily.

Furthermore, the first reference temperature is the glass transition temperature Tg of the toner T. In practice, the pressurizing time and the temperature drop rate may be controlled by taking the temperature in the vicinity of the glass transition temperature Tg as the reference. However, by taking the glass transition temperature Tg itself as the reference, it is possible to appropriately adjust the continuing time of the elastic deformation so as to acquire desired glossiness.

Furthermore, the fixer 12 includes the temperature retainer that keeps the temperature between the glass transition temperature Tg and the softening point temperature Ts of the toner T without pressurizing the toner T. Thereby, it is possible to appropriately secure the restoration time of the elastic deformation when desired to fix a low-gloss image even on a recording medium or the like with a small heat capacity.

Furthermore, the controller 21 shortens the pressurizing time for the case of fixing the low-gloss image than the case of fixing the high-gloss image. This makes it possible to easily adjust the restoration time of the elastic deformation after releasing the pressure according to the desired glossiness.

Furthermore, the controller 21 changes the heating degree by the gloss adjustor 30 according to increase and decrease in glossiness. That is, the elastic deformation is restored by keeping the temperature of the toner T to be at the softening point temperature Ts or lower for decreasing the gloss and the temperature of the toner T is set to be higher than the softening point temperature Ts to be fluidized for increasing the gloss so as to acquire a uniform surface. In this manner, the glossiness can be easily changed herein by the temperature control as well as control and the like of light irradiation time.

Furthermore, glossiness of each part is defined to be two kinds that are the high-gloss part and the low-gloss part, and the controller 21 makes selection between the first processing and the second processing based on the area ratio of the high-gloss part and the low-gloss part in the target image. That is, by making selection based on the area ratio to suppress the time and effort for making adjustment by the gloss adjustor 30, it is possible to easily and efficiently acquire a gloss image.

Furthermore, the controller 21 selects the first processing when the area of the low-gloss part is smaller than the area of the high-gloss part in the target image. That is, the adjustment target zone of the gloss adjustor 30 may simply be defined to be small. This makes it possible to securely reduce the time and effort required for the adjustment.

Furthermore, the controller 21 makes selection between the first processing and the second processing according to the power consumption of the gloss adjustor 30 when increasing the gloss by the operation of the gloss adjustor 30 and the power consumption of the gloss adjustor 30 when decreasing the gloss by the operation of the gloss adjustor 30. As described above, extra energy for increasing the temperature is required for acquiring high gloss by the operation of the gloss adjustor 30 than the case of acquiring low gloss. Therefore, by considering not simply the extent of the area but also the power consumption, the one with the smaller amount of power consumed for adjustment of the gloss may be selected. Thereby, efficiency of energy consumption can be improved.

Furthermore, the gloss adjustor 30 includes the light irradiator 31 that irradiates prescribed light. By irradiating the light to apply heat, the irradiation zone and irradiation amount can be minutely adjusted so that glossiness can be adjusted highly accurately without waste.

Furthermore, the gloss adjustor 30 is a post-processing apparatus separate from the fixer 12. Thereby, it is unnecessary to connect and operate the gloss adjustor 30 when not outputting an image having different kinds of glossiness. Therefore, efficiency of the image forming processing can be improved. Furthermore, it is also possible to form a whole image on which no gloss adjustment is performed, and the gloss adjustor 30 alone may separately perform the adjustment processing on the gloss part.

Furthermore, a gloss adjustment method of the image forming apparatus 100 according to the embodiments is the gloss adjustment method of the image forming apparatus including the fixer 12 that fixes the toner T on the recording medium M to the recording medium M and the gloss adjustor 30 that heats a set zone of the toner T fixed on the recording medium M by the fixer 12. The gloss adjustment method includes: a first adjustment step that adjusts glossiness of an image fixed by the fixer 12 based on the gloss information indicating glossiness in each part of the target image recorded on the recording medium M; and a second adjustment step that adjusts glossiness of a heating zone by the gloss adjustor 30 based on the gloss information.

As described, by appropriately combining glossiness of the image fixed by the fixer 12 with the zone and glossiness to be adjusted by the gloss adjustor 30, it is possible to suppress unnecessary time and effort and to efficiently form an image with a significant gloss difference.

Note that the present invention is not limited to the embodiments described above but various changes are possible.

For example, while the image is divided into two kinds that are the low-gloss part and the high-gloss part in the embodiments, glossiness may be set to three or more levels. In such case, a fixed image may be formed by aligning the gloss to the highest or lowest level, and the gloss may be adjusted toward the same increase or decrease direction for each level.

Furthermore, while the high-gloss part and the low-gloss part are defined to have a large difference in the embodiments described above, it may be defined to be adjustable in any gloss width.

Furthermore, while the gloss adjustor 30 is defined to irradiate light of a wavelength according to the toner T as described above, the light does not necessarily need to be visible light such as infrared rays or ultraviolet rays. Furthermore, not only the irradiation time but the intensity of the irradiation light may be changed according to the heating temperature. Moreover, the gloss adjustor 30 may keep or lower the temperature of the toner T without applying pressure by having the cooler, the heater, or the like brought in contact with the back face of the recording medium M.

Furthermore, while the temperature drop degree of the toner T is controlled in the embodiments described above by blowing air with the fan or switching contact or noncontact with the belt or the roller of a prescribed temperature, it is also possible to provide a temperature retaining chamber on the downstream side of the fixing roller 121 to adjust the inside temperature as necessary.

Furthermore, while only the power consumption of the gloss adjustor 30 is taken into consideration in the embodiments described above, the power consumption of the fixer 12 may be taken into consideration to make selection of the first processing and the second processing.

Furthermore, while the gloss adjustor 30 is described to be a separate component from the main body 10 in the embodiments described above, it is also possible to be integrated and held within a single structure.

In addition, specific details of the configuration, structures, processing contents, processing procedures, and the like described in the embodiments above can be changed as necessary without departing from the gist of the present invention. The scope of the present invention is not to be limited by the embodiments described above but includes the scope of the present invention described in the appended claims and the equivalent thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
a fixer that fixes a color material on a medium to the medium;
a heater that heats a zone set in the color material fixed to the medium by the fixer; and
a hardware processor that controls operations of the fixer and the heater, wherein the hardware processor performs adjustment of glossiness in an image fixed by the fixer and adjustment of glossiness in the zone heated by the heater based on gloss information indicating glossiness in each part of a target image recorded on the medium.

2. The image forming apparatus according to claim 1, wherein the hardware processor selects either a first gloss adjustment operation that fixes a prescribed gloss image by the fixer and then partially decreases gloss of the gloss image by the heater or a second gloss adjustment operation that fixes a low-gloss image having less gloss than the gloss image by the fixer and then partially increases gloss of the low-gloss image by the heater according to the gloss information.

3. The image forming apparatus according to claim 2, wherein:
the fixer comprises a pressurizer that heats the color material and presses the color material on the medium; and
the hardware processor defines a pressurization state by the pressurizer and tendency of temperature changes after starting heating until a temperature of the color material drops to a first reference temperature according to glossiness of the image fixed by the fixer.

4. The image forming apparatus according to claim 3, wherein the fixer extends time required for lowering the temperature of the color material to be longer for a case of fixing the low-gloss image than for a case of fixing the gloss image.

5. The image forming apparatus according to claim 3, wherein:
the fixer comprises a cooler that cools the color material; and
the hardware processor switches operations of the cooler according to glossiness of a whole image to be fixed.

6. The image forming apparatus according to claim 3, wherein the fixer lowers the temperature of the color material while pressurizing the color material by the pressurizer in the case of fixing the gloss image.

7. The image forming apparatus according to claim 3, wherein the first reference temperature is a glass transition temperature of the color material.

8. The image forming apparatus according to claim 7, wherein the fixer comprises a heat retainer that keeps the temperature to the glass transition temperature or higher and a softening point of the color material or lower without pressurizing the color material.

9. The image forming apparatus according to claim 2, wherein the hardware processor shortens pressurizing time by the pressurizer for a case of fixing the low-gloss image than a case of fixing the gloss image.

10. The image forming apparatus according to claim 1, wherein the hardware processor changes degrees of heat applied by the heater according to increase and decrease in glossiness.

11. The image forming apparatus according to claim 2, wherein:
glossiness of each of the parts is defined in two kinds that are a high-gloss part and a low-gloss part having lower gloss than the high-gloss part; and
the hardware processor makes selection between the first gloss adjustment operation and the second gloss adjustment operation based on an area ratio between the high-gloss part and the low-gloss part of the target image.

12. The image forming apparatus according to claim 11, wherein the hardware processor selects the first gloss adjustment operation when an area of the low-gloss part is smaller than an area of the high-gloss part in the target image.

13. The image forming apparatus according to claim 2, wherein the hardware processor makes selection between the first gloss adjustment operation and the second gloss adjustment operation according to power consumption of the heater when increasing the gloss by the operation of the heater and power consumption of the heater when decreasing the gloss by the operation of the heater.

14. The image forming apparatus according to claim 1, wherein the heater comprises a light irradiator that irradiates prescribed light.

15. The image forming apparatus according to claim 1, wherein the heater is a post-processing apparatus that is a separate component from the fixer.

16. A gloss adjustment method of an image forming apparatus comprising a fixer that fixes a color material on a medium to the medium, and a heater that heats a zone set in the color material fixed to the medium by the fixer, the gloss adjustment method comprising:
performing first adjustment of glossiness in an image fixed by the fixer based on gloss information indicating glossiness in each part of a target image recorded on the medium; and
performing second adjustment of glossiness in the zone heated by the heater based on the gloss information.
